(19) United States
(12) Patent Application Publication
(10) Pub. No.: US 2015/0213536 A1
(43) Pub. Date: Jul. 30, 2015

(54) METHOD AND APPARATUS FOR SEARCHING INFORMATION IN ELECTRONIC COMMERCE PLATFORM

(71) Applicant: Beijing Jingdong Shangke Information Technology Co., Ltd., Beijing (CN)

(72) Inventor: Junyu Liu, Shenzhen (CN)

(21) Appl. No.: 14/421,437

(22) PCT Filed: Aug. 9, 2013
(86) PCT No.: PCT/CN2013/081155

§ 371 Date: Feb. 12, 2015

(30) Foreign Application Priority Data
Aug. 13, 2012 (CN) 201210286512.X

(51) Int. Cl. G06Q 30/06; G06F 17/30

(52) U.S. Cl. CPC G06Q 30/0625; G06F 17/30342

(57) ABSTRACT

The present disclosure provides a method for searching information in electronic commerce platform including: organizing information in the electronic commerce platform in advance according to categories, products and commodities; wherein each product includes a product name and attribute information including attribute names and all possible attribute values corresponding to each attribute name; obtaining one search keyword, matching the search keyword with attribute values of each product, respectively, and using successfully matched products to form a first search result set; matching the search keyword with a product name of each product, respectively, and using successfully matched products to form a second search result set; displaying each search result. A displaying order of each search result in the first search result set takes precedent over a displaying order of each search result in the second search result set. Application of the solution of the present disclosure, accurate search results can be obtained.

### FIELD OF THE DISCLOSURE

The present disclosure relates to search technology, and more particularly to, a method and apparatus for searching information in electronic commerce platform.

### BACKGROUND

An existing electronic commerce platform usually uses following manner to achieve product search: obtaining search keywords from a user, matching the obtained search keywords with a variety of product names, respectively, and displaying successfully matched products as a search result for the user.

However, the above manner has some problems in practical applications. For example, if search information input by the user is NOKIA 5230, i.e., the user wants to search the mobile phone NOKIA 5230, two search keywords NOKIA and 5230 are obtained after word segmentation processing; then, both of two products whose names are “NOKIA 5230 (mobile phone)” and “NOKIA 5230 mobile phone film (film)”, according to the existing search manner, will be displayed as a search result for the user. Obviously, the latter product is not needed for the user, thereby reducing accuracy of the search result.

### SUMMARY

The present disclosure provides a method and apparatus for searching information in electronic commerce platform, which can improve accuracy of search results.

In order to achieve the above object, the technical solution of the present disclosure is achieved in that:

A method for searching information in electronic commerce platform, the method includes:

organizing information in the electronic commerce platform in advance according to categories, products and commodities; wherein the organizing information includes creating different categories; wherein creating each category includes determining a category name and attribute information of the category, the attribute information of the category including a variety of attribute names and all possible attribute values corresponding to each of the attribute names; creating a variety of affiliated products for each category, respectively; wherein creating each production includes determining a product name and attribute information of the product, the attribute information of the product includes: a variety of attribute names the same as the attribute names of the category to which the product belongs, and for each attribute name, attribute values corresponding to the product selected from the all possible attribute values corresponding to each attribute name, respectively; for each product, adding sale information on the basis of the product name and the attribute information of the product to form a commodity;

obtaining at least one search keyword;

matching the at least one search keyword with attribute values of each product, respectively, and using successfully matched products to form a first search result set;

matching the at least one search keyword with a product name of each product, respectively, and using successfully matched products to form a second search result set;

displaying each search result of the first search result set and the second search result set; wherein a displaying order of each search result in the first search result set takes precedent over a displaying order of each search result in the second search result set.

An apparatus for searching information in electronic commerce platform, the apparatus includes:

an organization module configured to organize information in the electronic commerce platform in advance according to categories, products and commodities; wherein the organizing information includes creating different categories; wherein creating each category includes determining a category name and attribute information of the category, the attribute information of the category including a variety of attribute names and all possible attribute values corresponding to each of the attribute names; wherein, for each category, the organization module is further configured to respectively create a variety of affiliated products; wherein creating each production includes determining a product name and attribute information of the product, the attribute information of the product including: a variety of attribute names the same as the attribute names of the category to which the product belongs, and for each attribute name, attribute values corresponding to the product selected from the all possible attribute values corresponding to each attribute name, respectively; wherein, for each product, the organization module is configured to add sale information on the basis of the product name and the attribute information of the product to form a commodity;

an obtaining module configured to obtain at least one search keyword and send the obtained at least one search keyword to a first search module and a second search module;

the first search module configured to match the at least one search keyword with attribute values of each product, respectively, use successfully matched products to form a first search result set, and send the first search result set to a display module;

the second search module configured to match the at least one search keyword with a product name of each product, respectively, use successfully matched products to form a second search result set, and send the second search result set to the display module;

the display module configured to display each search result of the first search result set and the second search result set; wherein a displaying order of each search result in the first search result set takes precedent over a displaying order of each search result in the second search result set.

In summary, applications of the solution of the present disclosure, search results obtained through searching according to attribute values, i.e., product, can be preferentially displayed for the user, since the attribute values reflects inherent characteristics of the products themselves such as brand, model, size, etc., thus, after searching according to the attribute values, the possibility of obtaining undesired search results, i.e., wrong search results, is smaller, thereby improving accuracy of search results.

Additionally, search results obtained through searching according to product names will be displayed for the user behind the search results obtained through searching according to attribute values, which can satisfy the user's existing search habits, but also provide more search results for the user.

Again, after applications of the solution of the present disclosure, searching can be performed in unit of product, thereby improving search efficiency.

### BRIEF DESCRIPTION OF DRAWINGS

FIG. 1 is a schematic diagram showing relationships between categories, products and commodities;

FIG. 2 is a flow chart of a method for organizing information in electronic commerce platform according to one embodiment;

FIG. 3 is a flow chart of a method for searching information in electronic commerce platform according to one embodiment of the present disclosure; and

FIG. 4 is a schematic diagram of an apparatus for searching information in electronic commerce platform according to one embodiment of the present disclosure.

### DETAILED DESCRIPTION

Aiming the problems existing in the existing technology, the present disclosure provides a method for searching information in electronic commerce platform, which can improve accuracy of search results.

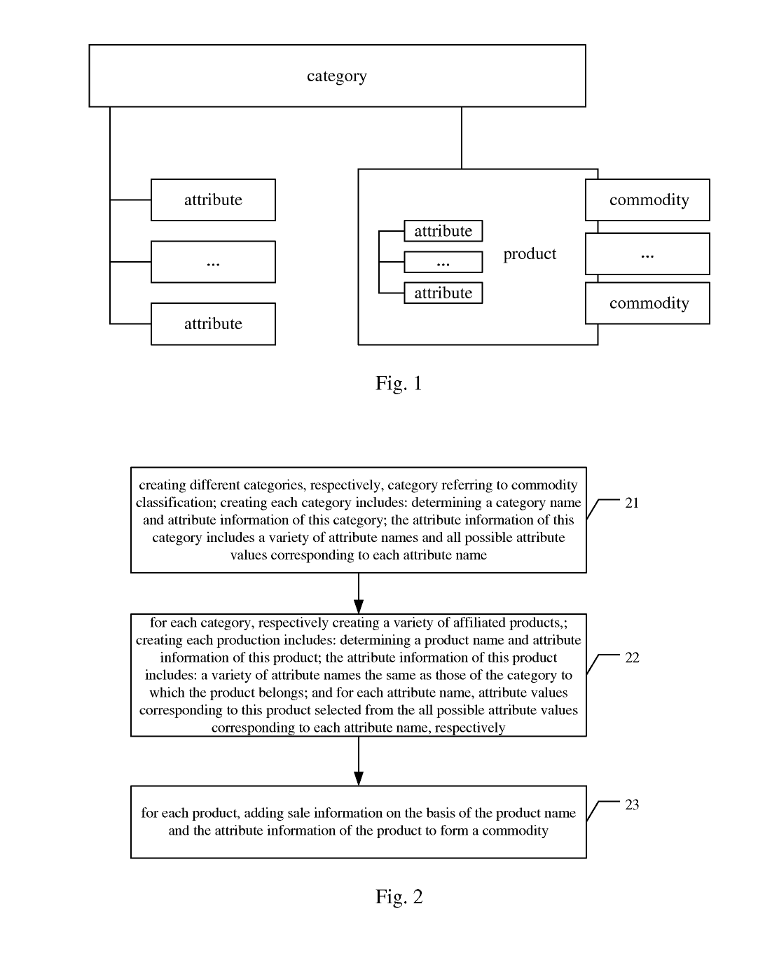

The solution of the present disclosure can be applied to scenes in which information in an electronic commerce platform is organized in advance according to categories, products and commodities. FIG. 1 is a schematic diagram showing relationships between categories, products and commodities. Formation of the structure shown in FIG. 1 will be described in detail with reference to embodiments.

FIG. 2 is a flow chart of a method for organizing information in electronic commerce platform according to one embodiment. As shown in FIG. 2, the method for organizing information in electronic commerce platform includes following blocks:

Block 21: creating different categories which refer to commodity classification; creating each category includes: determining a category name and attribute information of this category; the attribute information of this category includes a variety of attribute names and all possible attribute values corresponding to each attribute name.

In this block, different categories can be created. Specifically, if both of a category name and attribute information of one category have been determined, it indicates that creation of this category is completed. The attribute information is an attribute set which includes a plurality of attributes. Each attribute further includes an attribute name and all possible attribute values corresponding to the attribute name.

In practical applications, one attribute, i.e., one attribute name/attribute value, can be used to describe characteristics of one aspect of a commodity. Usually, people's understanding of one commodity is multi-dimensional, thus, one commodity usually has a plurality of characteristics needed to be described with a plurality of attribute names/attribute values.

For example, assuming that a category name of one created category is mobile phone, then, attribute names corresponding to the category name can include brand, model, screen size, system, color, and so on.

Accordingly, all possible attribute values corresponding to the attribute name brand can include all mobile phone brands currently appearing on the market, such as NOKIA, MOTO and so on.

All possible attribute values corresponding to the attribute name model can include all mobile phone models currently appearing on the market.

All possible attribute values corresponding to the attribute name screen size can include all mobile phone screen sizes currently appearing on the market, such as 3.2 inches, 4.0 inches, and so on.

All possible attribute values corresponding to the attribute name screen size can include all mobile phone screen sizes currently appearing on the market, such as 3.2 inches, 4.0 inches, and so on.

All possible attribute values corresponding to the attribute name system can include all mobile phone systems currently appearing on the market, such as Global System for Mobile Communications (GSM), Wideband Code Division Multiple Access (WCDMA), Code Division Multiple Access (CDMA), and so on.

All possible attribute values corresponding to the attribute name color can include a variety of colors, such as scarlet, orange, yellow, green, blue, purple, pink, white, black, white-blue, white-red, red-blue, white-pink, and so on.

Further, for the variety of attribute names of each category, the method can further include determining an attribute type to which each attribute name belongs.

The attribute type can include: key attribute, manufacture attribute and sale attribute. The sale attribute refers to attributes related to product sales behavior. The manufacture attribute refers to inherent attributes of a product and has nothing to do with product sales behavior. The manufacture attribute is determined after completion of manufacturing of the product. The key attribute is configured to uniquely identify a product. For example, brand and model belong to the key attribute, screen size and system belong to the manufacture attribute, and color belongs to the sale attribute.

In practical application, every time receiving a category creation instruction, a category creation interface can be displayed for the operation and maintenance personnel of the electronic commerce platform. The category creation interface can display a category name input box and an attribute information input box, etc., for the operation and maintenance personnel to input related information. The received information input in the category name input box by the operation and maintenance personnel can be taken as a category name of a category to be created; accordingly, the received information input in the attribute information input box by the operation and maintenance personnel can be taken as attribute information of the category to be created. The operation and maintenance personnel can be prompted in some way to select which one of the above three attribute types each attribute name belongs to. The attribute types selected by the operation and maintenance personnel can be taken as a attribute type to which each attribute name belongs.

There is no subordinate relationship between the categories, and different categories must have different attribute information.

After every category is created, the block 22 is performed; or, after all categories have been created, the block 22 is performed. The specific implementation is not limited.

Block 22: for each category, respectively creating a variety of affiliated products; creating each production includes: determining a product name and attribute information of this product; the attribute information of this product includes: a variety of attribute names the same as those of the category to which the product belongs; and for each attribute name, attribute values corresponding to this product selected from the all possible attribute values corresponding to each attribute name, respectively.

In this embodiment, the product can also be referred as standard product unit (SPU).

In this block, a variety of affiliated products are created for each category, respectively. If both of a product name and attribute information of one product have been determined, it indicates that creation of this product is completed. The attribute information includes: a variety of attribute names the same as those of the category to which the product belongs; and for each attribute name, attribute values corresponding to this product selected from all the possible attribute values corresponding to each attribute name, respectively.

Each product belongs to and only belongs to one category.

For example, assuming that one category is created with a category name of mobile phone, then, NOKIA 5230, NOKIA C5-03, Samsung, etc. are affiliated products of this category.

Taking creation of the product NOKIA 5230 as an example, when receiving a product creation instruction, a product creation interface can be displayed for the operation and maintenance personnel. The product creation interface can display a product name input box. The received information input in the product name input box by the operation and maintenance personnel can be taken as a product name, i.e., NOKIA 5230 of a product to be created. Further, according to the category to which the product belongs, the variety of attribute names and corresponding all possible attribute values of the category can be displayed in the interface. For each attribute name, the operation and maintenance personnel selects attribute values from all possible attribute values corresponding to the each attribute name and the selected attribute values are taken as attribute values corresponding to the product; for example, selecting the attribute value NOKIA from all possible attribute values corresponding to the attribute name brand;

selecting the attribute value 5230 from all possible attribute values corresponding to the attribute name model; selecting the attribute value 3.2 inches from all possible attribute values corresponding to the attribute name screen size; selecting two attribute values GSM and CDMA (supporting two kinds of systems) from all possible attribute values corresponding to the attribute name system; selecting four attribute values white, black, white-pink and white-blue (all colors appearing on the market) from all possible attribute values corresponding to the attribute name color.

Furthermore, after every product is created, a tag can be created for this product. For example, a tag input box can also be displayed in the above product creation interface, and information input in the tag input box by the operation and maintenance personnel can be taken as a tag of the product NOKIA 5230. The specific contents of the tag can be determined according to actual needs. For example, the tag can be used to further illustrate characteristics, etc. of the product.

Moreover, other items such as product image, product comment and product score can also be created for each product, which can be determined according to actual needs.

Block 23: for each product, adding sale information on the basis of the product name and the attribute information of the product to form a commodity.

In practical applications, for each product, sale information of different vendors can be added on the basis of the product name and the attribute information of the product to form different commodities.

The sale information usually at least includes: vendor name and quotation. The sale information can further include other information, such as, inventory, commodity image, sale attributes (for example, colors) of stock commodities.

If it is to organize information existed in the electronic commerce platform in the manner described in this embodiment, then, the sale information of different vendors is existing in advance and is processed in the manner described in the block 23 to obtain different commodities.

If one vendor wants to release one commodity in the electronic commerce platform after completion of the organization, the vendor can log into the electronic commerce platform, find a product corresponding to the commodity, and then set sale information for this product so as to obtain a commodity. Further, the vendor can also add attributes to this product. For example, for the product NOKIA 5230, original attribute information does not include an attribute screen color, then an attribute screen color can be added as: attribute name: screen color; attribute value: 16 million colors.

After the block 23 is performed, a mapping relation can be established between each category name and a corresponding class, and the variety of commodities can be displayed in manner of an existing class map. That is to say, each commodity is no longer binding with the class, and it is only needed to establish a corresponding relationship between each category name and corresponding class. In this way, if it is needed to modify the class to which one commodity belongs, it is only needed to modify the mapping relation between the class and the category name. Taking a printer as an example, from the perspective of consumers, the original class to which the printer belongs is computer peripheral; if it is desired to modify the class to which the printer belongs to be office supply, it is only needed to modify a mapping relation between a category name printer and a corresponding class from original mapping to the class computer peripheral, to mapping to the class office supply.

Based on the above introduction, the method for searching information in electronic commerce platform of the present disclosure will be described in detail with reference to the accompanying drawings and embodiments.

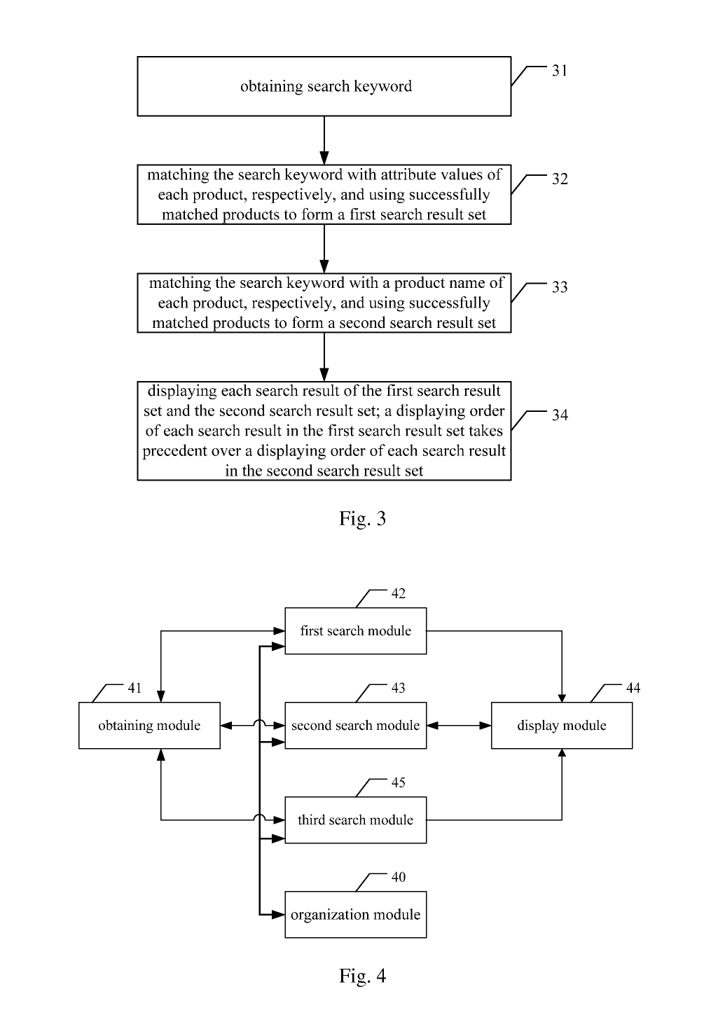

FIG. 3 is a flow chart of a method for searching information in electronic commerce platform according to one embodiment of the present disclosure. As shown in FIG. 3, the method for searching information in electronic commerce platform includes:

Block 31: obtaining at least one search keyword.

In this block, search information input by a user is received, and the at least one search keyword can be obtained through performing word segmentation processing on the search information, and so on.

The number of the obtained search keywords may be one, and may also be more than one.

Block 32: matching the at least one search keyword with attribute values of each product, respectively, and using successfully matched products to form a first search result set.

If the number of the search keywords obtained in the block 31 is one, then, the first search result set will include: search results which successfully match with the search keyword.

If the number of the search keywords obtained in the block 31 is more than one, i.e., multiple, then, the first search result set will include one of the following or any combination thereof: search results which each only match with one search keyword, search results which each match with all the search keywords, and search results which each match with a part of the search keywords and a number of the part of the search keywords is greater than one and less than the number of all the search keywords. For example, assuming that the number of the search keywords obtained in the block 31 is three, then, the search results which each match with a part of the search keywords refer to search results which each match with two of the search keywords.

Block 33: matching the at least one search keyword with a product name of each product, respectively, and using successfully matched products to form a second search result set.

If the number of the search keywords obtained in the block 31 is one, then, the second search result set will include: search results which successfully match with the search keyword.

If the number of the search keywords obtained in the block 31 is multiple, then, the second search result set will include one of the following or any combination thereof: search results which each only match with one search keyword, search results which each match with all the search keywords, and search results which each match with a part of the search keywords and a number of the part of the search keywords is greater than one and less than the number of all the search keywords.

Block 34: displaying each search result of the first search result set and the second search result set; a displaying order of each search result in the first search result set takes precedent over a displaying order of each search result in the second search result set.

As described above, each produce can contain a product name and attribute information which contains attribute names and corresponding attribute values. Further, a tag can be created for each product, and contents of the tag are usually set by an operation and maintenance personnel of the electronic commerce platform and can be amended according to needs.

Accordingly, in addition to matching respectively the at least one search keyword obtained in the block 31 with attribute values and a product name of each product to obtain the first search result set and the second search result set, the method can further include matching the at least one search keyword obtained in the block 31 with the tag of each product and using successfully matched products to form a third search result set.

If the number of the search keywords obtained in the block 31 is one, then, the third search result set will include: search results which successfully match with the search keyword.

If the number of the search keywords obtained in the block 31 is multiple, then, the third search result set will include one of the following or any combination thereof: search results which each only match with one search keyword, search results which each match with all the search keywords, and search results which each match with a part of the search keywords and a number of the part of the search keywords is greater than one and less than the number of all the search keywords.

Accordingly, in the block 34, each search result of the third search result set can be displayed at the same time displaying each search result of the first search result set and the second search result set. The displaying order of each search result in the second search result set takes precedent over a displaying order of each search result in the third search result set. That is to say, the displaying order of each search result in the first search result set takes precedent over the displaying order of each search result in the second search result set, and the displaying order of each search result in the second search result set further takes precedent over the displaying order of each search result in the third search result set.

In practical applications, before displaying each search result of the second search result set, duplicate search results between the first search result set and the second search result can further be deleted from the second search result set. Similarly, before displaying each search result of the third search result set, duplicate search results between the third search result set and the first search result set and/or the second search result can further be deleted from the third search result set. That is, for any search result, if it has already been displayed in front, it will not be displayed again.

Moreover, if the number of the search keywords obtained in the block 31 is multiple, when displaying each search result of the first search result set, the more the matched search keywords, the more front the displaying order. Similarly, when displaying each search result of the second search result set, the more the matched search keywords, the more front the displaying order. When displaying each search result of the third search result set, the more the matched search keywords, the more front the displaying order.

The above process can be overall illustrated with an example as follows:

assuming that the search information input by the user is NOKIA 5230, i.e., the user wants to search the mobile phone NOKIA 5230, two search keywords NOKIA and 5230 are obtained after word segmentation processing; for ease of expression, in this example, the search keyword NOKIA can be referred as search keyword A, and the search keyword 5230 can be referred as search keyword B;

matching the two search keywords with attribute values of each product, respectively, to obtain a first search result set; assuming that the first search result set contains three search results which can be a search result X, a search result Y and a search result Z, respectively, the search result X only successfully matches with the search keyword A, the search result Y only successfully matches with the search keyword B, and the search result Z successfully matches with both of the search keyword A and the search keyword B;

matching the two search keywords with a product name of each product, respectively, to obtain a second search result set; assuming that the second search result set contains three search results which can be a search result X′, a search result Y′ and a search result Z′, respectively, the search result X′ only successfully matches with the search keyword A, the search result Y′ only successfully matches with the search keyword B, and the search result Z′ successfully matches with both of the search keyword A and the search keyword B;

matching the two search keywords with a tag of each product, respectively, to obtain a third search result set; assuming that the third search result set contains three search results which can be a search result X″, a search result Y″ and a search result Z″, respectively, the search result X″ only successfully matches with the search keyword A, the search result Y″ only successfully matches with the search keyword B, and the search result Z″ successfully matches with both of the search keyword A and the search keyword B;

then, nine search results are needed too be displayed for the user in sequence of priority: the search result Z, the search result X, the search result Y, the search result Z′, the search result X′, the search result Y′, the search result Z″, the search result X″, and the search result y″.

In practical applications, different weights can be set for the search keyword A and the search keyword B. A displaying order of a search result corresponding to a search keyword with a higher weight takes precedent over a displaying order of a search result corresponding to a search keyword with a smaller weight. Assuming that in this example, the search keyword A has a higher weight, thus, the search result X will be displayed in front of the search result Y.

Based on the above introduced contents, the solution of the present disclosure further includes:

After each search result of each search result set has been displayed, if a precise matching instruction is received, calculating an intersection of the first search result set and the second search result set, to obtain a fourth search result set, and displaying only each search result of the fourth search result set.

How the user sends the precise matching instruction is not limited. For example, a precise matching button can be displayed at a location of a page which displays each search result of each search result set; when detecting that the user clicks on the button, then determining that the user sends the precise matching instruction.

As described above, if the number of the search keywords obtained in the block 31 is more than one, the first search result set will include one of the following or any combination thereof: search results which each only successfully match with one search keyword, search results which each successfully match with all the search keywords, and search results which each successfully match with a part of the search keywords; a number of the part of the search keywords is greater than one and less than the number of all the search keywords. The second search result set will include one of the following or any combination thereof: search results which each only successfully match with one search keyword, search results which each successfully match with all the search keywords, and search results which each successfully match with a part of the search keywords.

Since the fourth search result set is an intersection of the first search result and the second search result, thus, the fourth search result set will also include one of the following or any combination thereof: search results which each only successfully match with one search keyword, search results which each successfully match with all the search keywords, and search results which each successfully match with a part of the search keywords. Accordingly, displaying each search result of the fourth search result set also likewise needs to follow the principle of the more the matched search keywords, the more front the displaying order.

Since the search results of the fourth search result set are contained in the first search result set and are also contained in the second search result set, thus, this further reduces possibility of wrong search results, thereby further improving accuracy of search results.

Furthermore, in the solution of the present disclosure, when displaying each search result, i.e., each product, the displayed specific information can include: product name, attribute information, product picture, price range (lowest quotation˜highest quotation for commodities belonging to this product), and so on. What information is specifically displayed can be determined according to actual needs. Moreover, the user can trigger in some way to display a variety of commodities belonging to this product.

At this point, the introduction about the method of one embodiment of the present disclosure is completed.

Based on the above introduction, FIG. 4 is a schematic diagram of an apparatus for searching information in electronic commerce platform according to one embodiment of the present disclosure. As shown in FIG. 4, the apparatus includes:

an organization module 40 configured to organize information in an electronic commerce platform in advance according to categories, products and commodities; the organizing information including: creating different categories; the creating each category including: determining a category name and attribute information of this category; the attribute information of this category including a variety of attribute names and all possible attribute values corresponding to each attribute name; for each category, the organization module 40 is further configured to respectively create a variety of affiliated products; creating each production including: determining a product name and attribute information of this product; the attribute information of this product including: a variety of attribute names the same as those of the category to which the product belongs; and for each attribute name, attribute values corresponding to this product selected from the all possible attribute values corresponding to each attribute name, respectively; for each product, the organization module 40 is configured to add sale information on the basis of the product name and the attribute information of the product to form a commodity;

an obtaining module 41 configured to, every time when needing to perform information search, obtain at least one search keyword and send the obtained at least one search keyword to a first search module 42 and a second search module 43;

the first search module 42 configured to match the at least one search keyword with attribute values of each product, respectively, use successfully matched products to form a first search result set, and send the first search result set to a display module 44;

the second search module 43 configured to match the at least one search keyword with a product name of each product, respectively, use successfully matched products to form a second search result set, and send the second search result set to the display module 44;

the display module 44 configured to display each search result of the first search result set and the second search result set; a displaying order of each search result in the first search result set takes precedent over a displaying order of each search result in the second search result set.

The organization module 40 is further configured to create a tag for each product; accordingly, the apparatus shown in FIG. 4 further includes a third search module 45;

the obtaining module 41 further sends the at least one search keyword to the third search module 45;

the third search module 45 configured to match the at least one search keyword with the tag of each product, use successfully matched products to form a third search result set, and send the third search result set to the display module 44;

the display module 44 displays each search result of the third search result set at the same time displaying each search result of the first search result set and the second search result set; the displaying order of each search result in the second search result set taking precedent over a displaying order of each search result in the third search result set.

Moreover, the display module 44 is further configured to, before displaying each search result of the second search result set, delete duplicate search results between the first search result set and the second search result from the second search result set; before displaying each search result of the third search result set, delete duplicate search results between the third search result set and the first search result set and/or the second search result from the third search result set.

If the number of the search keywords is greater than one, the first search result set includes one of the following or any combination thereof:

search results which each only successfully match with one search keyword, search results which each successfully match with all the search keywords, and search results which each successfully match with a part of the search keywords; a number of the part of the search keywords is greater than one and less than the number of all the search keywords;

the second search result set includes one of the following or any combination thereof: search results which each only successfully match with one search keyword, search results which each successfully match with all the search keywords, and search results which each successfully match with a part of the search keywords;

the third search result set includes one of the following or any combination thereof: search results which each only successfully match with one search keyword, search results which each successfully match with all the search keywords, and search results which each successfully match with a part of the search keywords;

accordingly, the display module 44 is further configured to, for each search result of the first search result set, the second search result set and the second search result set, set a displaying order for each search result in a manner of the more the matched search keywords, the more front the displaying order.

The display module 44 can also be further configured to, after each search result of each search result set has been displayed, if a precise matching instruction is received, calculate an intersection of the first search result set and the second search result set to obtain a fourth search result set, and display only each search result of the fourth search result set.

If the number of the search keywords is greater than one,

the first search result set includes one of the following or any combination thereof: search results which each only successfully match with one search keyword, search results which each successfully match with all the search keywords, and search results which each successfully match with a part of the search keywords; a number of the part of the search keywords is greater than one and less than the number of all the search keywords;

the second search result set includes one of the following or any combination thereof: search results which each only successfully match with one search keyword, search results which each successfully match with all the search keywords, and search results which each successfully match with a part of the search keywords;

accordingly, the display module 44 is further configured to, for each search result of the fourth search result set, set a displaying order for each search result in a manner of the more the matched search keywords, the more front the displaying order.

A specific workflow of the embodiment of the apparatus shown in FIG. 4 refers to corresponding instructions of the aforementioned embodiment of the method, and will not be repeated here.

In summary, applications of the solution of the present disclosure, search results obtained through searching according to attribute values, i.e., product, can be preferentially displayed for the user, since the attribute values reflects inherent characteristics of the products themselves such as brand, model, size, etc., thus, after searching according to the attribute values, the possibility of obtaining undesired search results, i.e., wrong search results, is smaller, thereby improving accuracy of search results.

For example, the search information input by the user is NOKIA 5230, for two products whose product names are “NOKIA 5230” and “NOKIA 5230 mobile phone film”, respectively, since the attribute values of the product “NOKIA 5230” include two keywords including NOKIA and 5230, thus, the product “NOKIA 5230” will be displayed as a search result for the user. As described above, the attribute values reflects inherent characteristics of the products themselves such as brand, then, for the product “NOKIA 5230 mobile phone film”, the attribute values of the product “NOKIA 5230 mobile phone film” include only information about the file itself such as size, thickness and so on. That is to say, the attribute values of the product “NOKIA 5230 mobile phone film” do not include any one of the keywords NOKIA and 5230, thus, the product “NOKIA 5230 mobile phone film” will not be displayed as a search result for the user.

Additionally, search results obtained through searching according to product names will be displayed for the user behind the search results obtained through searching according to attribute values, which can satisfy the user's existing search habits, but also provide more search results for the user.

Again, after applications of the solution of the present disclosure, searching can be performed in unit of product, thereby improving search efficiency.

The methods and modules described herein may be implemented by hardware, machine-readable instructions or a combination of hardware and machine-readable instructions. Machine-readable instructions used in the examples disclosed herein may be stored in storage medium readable by at least one or more processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. Specifically, a system or apparatus having a storage medium that stores machine-readable program codes for implementing functions of any of the above examples and that may cause the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

The foregoing are only preferred embodiments of the present disclosure, and are not used to limit the present disclosure. Any modification, equivalent replacement, or improvement made without departing from the spirit and principle of the present disclosure should fall within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and apparatus, search results obtained through searching according to attribute values, i.e., product, can be preferentially displayed for the user, since the attribute values reflects inherent characteristics of the products themselves such as brand, model, size, etc., thus, after searching according to the attribute values, the possibility of obtaining undesired search results, i.e., wrong search results, is smaller, thereby improving accuracy of search results. Further, search results obtained through searching according to product names will be displayed for the user behind the search results obtained through searching according to attribute values, which can satisfy the user's existing search habits, but also provide more search results for the user.

What is claimed is:

1. A method for searching information in electronic commerce platform, the method comprising:
organizing information in the electronic commerce platform in advance according to categories, products and commodities; wherein the organizing information comprises creating different categories; wherein creating each category comprises determining a category name and attribute information of the category, the attribute information of the category comprising a variety of attribute names and all possible attribute values corresponding to each of the attribute names; creating a variety of affiliated products for each category, respectively; wherein creating each production comprises determining a product name and attribute information of the product, the attribute information of the product comprises: a variety of attribute names the same as the attribute names of the category to which the product belongs, and for each attribute name, attribute values corresponding to the product selected from the all possible attribute values corresponding to each attribute name, respectively; for each product, adding sale information on the basis of the product name and the attribute information of the product to form a commodity;
obtaining at least one search keyword;
matching the at least one search keyword with attribute values of each product, respectively, and using successfully matched products to form a first search result set;
matching the at least one search keyword with a product name of each product, respectively, and using successfully matched products to form a second search result set;
displaying each search result of the first search result set and the second search result set; wherein a displaying order of each search result in the first search result set takes precedent over a displaying order of each search result in the second search result set.

2. The method of claim 1, wherein the method further comprises creating a tag for each product;
before the displaying each search result of the first search result set and the second search result set, the method further comprises: matching the at least one search keyword with the tag of each product and using successfully matched products to form a third search result set;
the method further comprises: displaying each search result of the third search result set at the same time displaying each search result of the first search result set and the second search result set; wherein the displaying order of each search result in the second search result set takes precedent over a displaying order of each search result in the third search result set.

3. The method of claim 2, wherein
before the displaying each search result of the second search result set, the method further comprises: deleting duplicate search results between the first search result set and the second search result from the second search result set;
before the displaying each search result of the third search result set, the method further comprises: deleting duplicate search results between the third search result set and the first search result set and/or the second search result from the third search result set.

4. The method of claim 2, wherein if a number of the search keywords is greater than one,
the first search result set comprises one of the following or any combination thereof: search results which each only successfully match with one search keyword, search results which each successfully match with all the search keywords, and search results which each successfully match with a part of the search keywords; a number of the part of the search keywords is greater than one and less than the number of all the search keywords;
the second search result set comprises one of the following or any combination thereof: search results which each only successfully match with one search keyword, search results which each successfully match with all the search keywords, and search results which each successfully match with a part of the search keywords;
the third search result set comprises one of the following or any combination thereof: search results which each only successfully match with one search keyword, search results which each successfully match with all the search keywords, and search results which each successfully match with a part of the search keywords;
the displaying each search result of the first search result set comprises: for each search result of the first search result set, setting a displaying order for each search result in a manner of the more the matched search keywords, the more front the displaying order;
the displaying each search result of the second search result set comprises: for each search result of the second search result set, setting a displaying order for each search result in a manner of the more the matched search keywords, the more front the displaying order;
the displaying each search result of the third search result set comprises: for each search result of the third search result set, setting a displaying order for each search result in a manner of the more the matched search keywords, the more front the displaying order.

5. The method of claim 1, wherein after each search result of each search result set has been displayed, the method further comprises:
if a precise matching instruction is received, calculating an intersection of the first search result set and the second search result set to obtain a fourth search result set, and displaying only each search result of the fourth search result set.

6. The method of claim 5, wherein if the number of the search keywords is greater than one,
the first search result set comprises one of the following or any combination thereof: search results which each only successfully match with one search keyword, search results which each successfully match with all the search keywords, and search results which each successfully match with a part of the search keywords; a number of the part of the search keywords is greater than one and less than the number of all the search keywords;
the second search result set comprises one of the following or any combination thereof: search results which each only successfully match with one search keyword, search results which each successfully match with all the search keywords, and search results which each successfully match with a part of the search keywords;
the displaying each search result of the fourth search result set comprises: for each search result of the fourth search result set, setting a displaying order for each search result in a manner of the more the matched search keywords, the more front the displaying order.

7. An apparatus for searching information in electronic commerce platform, the apparatus comprising:
an organization module configured to organize information in the electronic commerce platform in advance according to categories, products and commodities; wherein the organizing information comprises creating different categories; wherein creating each category comprises determining a category name and attribute information of the category, the attribute information of the category comprising a variety of attribute names and all possible attribute values corresponding to each of the attribute names; wherein, for each category, the organization module is further configured to respectively create a variety of affiliated products; wherein creating each production comprises determining a product name and attribute information of the product, the attribute information of this product comprising: a variety of attribute names the same as the attribute names of the category to which the product belongs, and for each attribute name, attribute values corresponding to the product selected from the all possible attribute values corresponding to each attribute name, respectively; wherein, for each product, the organization module is configured to add sale information on the basis of the product name and the attribute information of the product to form a commodity;
an obtaining module configured to obtain at least one search keyword and send the obtained at least one search keyword to a first search module and a second search module;
the first search module configured to match the at least one search keyword with attribute values of each product, respectively, use successfully matched products to form a first search result set, and send the first search result set to a display module;
the second search module configured to match the at least one search keyword with a product name of each product, respectively, use successfully matched products to form a second search result set, and send the second search result set to the display module;
the display module configured to display each search result of the first search result set and the second search result set; wherein a displaying order of each search result in the first search result set takes precedent over a displaying order of each search result in the second search result set.

8. The apparatus of claim 7, wherein the organization module is further configured to create a tag for each product; the apparatus further comprises a third search module;
the obtaining module further sends the at least one search keyword to the third search module;
the third search module is configured to match the at least one search keyword with the tag of each product, use successfully matched products to form a third search result set and send the third search result set to the display module;
the display module displays each search result of the third search result set at the same time displaying each search result of the first search result set and the second search result set; wherein the displaying order of each search result in the second search result set takes precedent over a displaying order of each search result in the third search result set.

9. The apparatus of claim 8, wherein the display module is further configured to,
before displaying each search result of the second search result set, delete duplicate search results between the first search result set and the second search result from the second search result set;
before displaying each search result of the third search result set, delete duplicate search results between the third search result set and the first search result set and/or the second search result from the third search result set.

10. The apparatus of claim 8, wherein if a number of the search keywords is greater than one,
the first search result set comprises one of the following or any combination thereof: search results which each only successfully match with one search keyword, search results which each successfully match with all the search keywords, and search results which each successfully match with a part of the search keywords; a number of the part of the search keywords is greater than one and less than the number of all the search keywords;
the second search result set comprises one of the following or any combination thereof: search results which each only successfully match with one search keyword, search results which each successfully match with all the search keywords, and search results which each successfully match with a part of the search keywords;
the third search result set comprises one of the following or any combination thereof: search results which each only successfully match with one search keyword, search results which each successfully match with all the search keywords, and search results which each successfully match with a part of the search keywords;
the display module is further configured to, for each search result of the first search result set, the second search result set and the second search result set, set a displaying order for each search result in a manner of the more the matched search keywords, the more front the displaying order.

11. The apparatus of claim 7, wherein the display module is further configured to,
after each search result of each search result set has been displayed, if a precise matching instruction is received, calculate an intersection of the first search result set and the second search result set to obtain a fourth search result set, and display only each search result of the fourth search result set.

12. The apparatus of claim 11, wherein if the number of the search keywords is greater than one,
the first search result set comprises one of the following or any combination thereof: search results which each only successfully match with one search keyword, search results which each successfully match with all the search keywords, and search results which each successfully match with a part of the search keywords; a number of the part of the search keywords is greater than one and less than the number of all the search keywords;
the second search result set comprises one of the following or any combination thereof: search results which each only successfully match with one search keyword, search results which each successfully match with all the search keywords, and search results which each successfully match with a part of the search keywords;
the display module is further configured to, for each search result of the fourth search result set, set a displaying order for each search result in a manner of the more the matched search keywords, the more front the displaying order.

13. A computer-readable storage medium comprising a set of instructions for searching information in electronic commerce platform, the set of instructions to direct at least one processor to perform acts of:
organizing information in the electronic commerce platform in advance according to categories, products and commodities; wherein the organizing information comprises creating different categories; wherein creating each category comprises determining a category name and attribute information of the category, the attribute information of the category comprising a variety of attribute names and all possible attribute values corresponding to each of the attribute names; creating a variety of affiliated products for each category, respectively; wherein creating each production comprises determining a product name and attribute information of this product, the attribute information of the product comprises: a variety of attribute names the same as the attribute names of the category to which the product belongs, and for each attribute name, attribute values corresponding to the product selected from the all possible attribute values corresponding to each attribute name, respectively; for each product, adding sale information on the basis of the product name and the attribute information of the product to form a commodity;
obtaining at least one search keyword;
matching the at least one search keyword with attribute values of each product, respectively, and using successfully matched products to form a first search result set;
matching the at least one search keyword with a product name of each product, respectively, and using successfully matched products to form a second search result set;
displaying each search result of the first search result set and the second search result set; wherein a displaying order of each search result in the first search result set takes precedent over a displaying order of each search result in the second search result set.
